(19) United States
(12) Patent Application Publication
(10) Pub. No.: US 2024/0069864 A1
(43) Pub. Date: Feb. 29, 2024

(54) HARDWARE ACCELERATOR FOR FLOATING-POINT OPERATIONS

(71) Applicant: Avago Technologies International Sales Pte. Limited, Singapore (SG)

(72) Inventors: Brian SCHONER, Fremont, CA (US); Xiaocheng HE, San Jose, CA (US)

(73) Assignee: Avago Technologies International Sales Pte. Limited, Singapore (SG)

(21) Appl. No.: 17/898,201

(22) Filed: Aug. 29, 2022

(51) Int. Cl. G06F 7/483; G06F 7/544; G06F 7/74

(52) U.S. Cl. CPC G06F 7/483; G06F 7/544; G06F 7/74

(57) ABSTRACT

A device includes integer multiplier circuits, a multiplexer circuit configured to provide portions of mantissas of a set of first data elements having a floating-point data type and portions of mantissas of a set of second data elements having the floating-point data type to respective integer multiplier circuits, wherein each integer multiplier circuit is configured to multiply a respective portion of the mantissa of a first data element by a respective portion of the mantissa of a second data element to generate a partial product. The device further includes output circuits configured to generate an output data element based on the partial products generated by the integer multiplier circuits and exponents of the set of first data elements and of the set of second data elements. The multiplexer circuit is further configured to bypass providing least-significant portions of the mantissas of the set of first data elements to integer multiplier circuits for multiplication with least-significant portions of the mantissas of the set of second data elements.

### TECHNICAL FIELD

The present description relates generally to hardware acceleration including, for example, hardware acceleration for floating-point operations.

### BACKGROUND

Floating-point data types can represent ranges of real numbers broader than the ranges available using integer data types. Machine-learning models commonly use floating-point data types for data elements such as features and weights used in convolutional neural networks. However, operations such as multiplication using floating-point data types can be more complicated and slower than operations using integer data types.

### BRIEF DESCRIPTION OF THE DRAWINGS

Certain features of the subject technology are set forth in the appended claims. However, for purposes of explanation, several aspects of the subject technology are depicted in the following figures.

FIG. 1 is a block diagram depicting components of a convolution hardware accelerator device/system according to aspects of the subject technology.

FIG. 2 is a block diagram depicting components of a multiplication and accumulation cell according to aspects of the subject technology.

FIG. 3 contains a flowchart illustrating an example multiplication and accumulation operation of a MAC cell for a 32-bit floating-point data type according to aspects of the subject technology.

FIG. 4 is a block diagram depicting multiplication operations performed by the integer multiplier circuits on the portions of the mantissas according to aspects of the subject technology.

FIGS. 5A and 5B are block diagram depicting multiplication operations performed by the integer multiplier circuits on the portions of the mantissas according to aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block-diagram form in order to avoid obscuring the concepts of the subject technology.

Machine-learning models such as convolutional neural networks include one or more convolution layers. Each convolution layer is configured to convolve an input tensor of input feature elements with a kernel of weight elements to generate an output tensor of output feature elements. The feature elements of the input tensor may be data values of an object, such as pixel values of an image or elements of a feature map generated by a previous layer in the neural network, provided as input to a convolution layer. The weight elements of the kernel may be data values used to filter the feature elements of the input tensor using a convolution operation to generate the output feature elements of the output tensor and may be modified during iterations of training the neural network. Input tensors, kernels, and output tensors may be single-dimensional or multidimensional arrays of data elements.

The core computations of a convolution operation include the multiplication of different combinations of input feature elements and weight elements, which commonly use floating-point data types (e.g., float 32, float16). Accordingly, the performance of floating-point multiplication operations in a hardware accelerator can significantly impact the accuracy, costs, and power usage of the hardware accelerator. Performance improvements may be sought by changing the floating-point data type used for the data elements to a smaller floating-point data type (e.g., changing from float32 to float16), which can be processed more quickly than if larger floating-point data types are used. However, the improved performance in processing time comes with accuracy loss since a lower-precision floating-point data type is used. Performance improvements also may be sought by increasing hardware resources available in the hardware accelerator to be able to execute more floating-point operations in parallel. While adding hardware resources can improve performance without sacrificing accuracy, additional hardware resources may increase manufacturing costs of the hardware accelerator and also may increase power usage of the hardware accelerator during operation.

The subject technology provides a hardware accelerator that improves the performance of floating-point multiplication operations while maintaining the precision of the floating-point data elements (e.g., number of mantissa bits and number of exponent bits) used in the multiplication operations. For example, floating-point multiplication operations include multiplying the mantissas of the two floating-point data elements. To accommodate multiplier circuits that have a smaller bit size than the number of bits in the mantissas, the multiplication operation may be divided into multiple operations where each operation multiplies a different pair of portions of the mantissas to generate partial products that are summed to generate the product of the two mantissas. The bit size of a multiplier circuit may refer to the maximum number of bits that may be used to represent the two values being multiplied by the multiplier circuit. According to aspects of the subject technology, the number of multiplication operations is reduced by not multiplying the portions of the mantissas having the least-significant bits from the respective mantissas and excluding that partial product from the overall multiplication operation. This modification reduces the number of multiplication operations with a minimal impact on the accuracy of the results. Other features and aspects of the subject technology are described below.

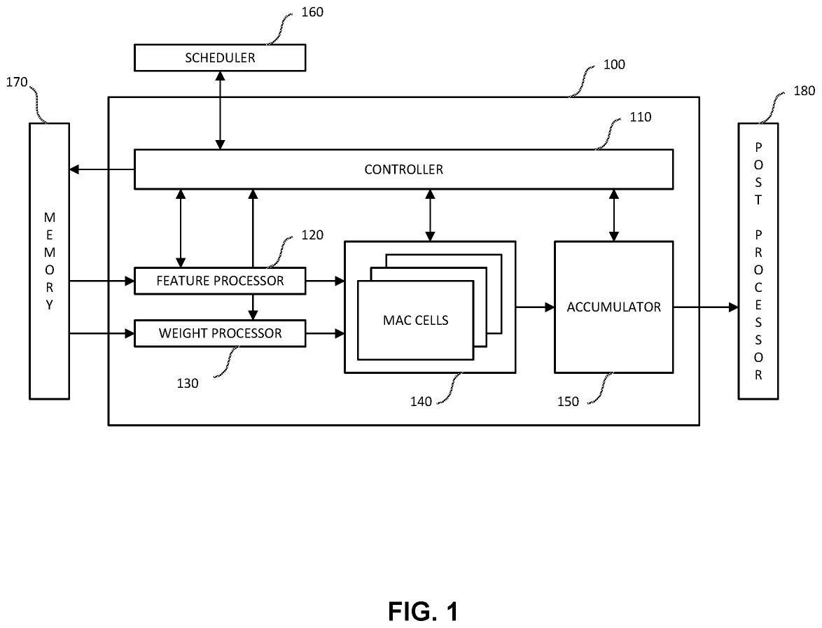

FIG. 1 is a block diagram depicting components of a convolution hardware accelerator device/system according to aspects of the subject technology. Not all of the depicted components may be required, however, and one or more implementations may include additional components not shown in the figure. Variations in the arrangement and type of the components may be made without departing from the spirit or scope of the claims as set forth herein. Depicted or described connections and couplings between components are not limited to direct connections or direct couplings and may be implemented with one or more intervening components unless expressly stated otherwise. In addition, the operations of the convolution hardware accelerator device/system described below may include additional and/or intervening operations unless expressly stated otherwise.

As depicted in FIG. 1, convolution hardware accelerator device/system 100 includes controller circuit 110, feature processor circuit 120, weight processor circuit 130, multiplication and accumulation (MAC) cells 140, and accumulator circuit 150. All the components of convolution hardware accelerator device/system 100 may be implemented in a single semiconductor device, such as a system on a chip (SoC). Alternatively, one or more of the components of convolution hardware accelerator device/system 100 may be implemented in a semiconductor device separate from the other components and mounted on a printed circuit board, for example, with the other components to form a system. In addition, one or more circuit elements may be shared between multiple circuit components depicted in FIG. 1. The subject technology is not limited to these two alternatives and may be implemented using other combinations of chips, devices, packaging, etc. to implement convolution hardware accelerator device/system 100.

Controller circuit 110 includes suitable logic, circuitry, and/or code to control operations of the components of convolution hardware accelerator device/system 100 to convolve an input tensor with a kernel to generate an output tensor. For example, controller circuit 110 may be configured to parse a command written to a command register (not shown) by scheduler 160 for a convolution operation. The command may include parameters for the convolution operation such as data types of the elements, a location of the input tensor in memory 170, a location of the kernel(s) in memory 170, a stride value for the convolution operation, etc. Using the parameters for the convolution operation, controller circuit 110 may configure and/or provide commands/instructions to feature processor circuit 120, weight processor circuit 130, MAC cells 140, and accumulator circuit 150 to perform a convolution operation and provide a resulting output tensor to post processor 180. The command register may be incorporated into controller circuit 110 or may be implemented as a separate component accessible to controller circuit 110 within convolution hardware accelerator device/system 100.

Scheduler 160 may be configured to interface with one or more other processing elements not shown in FIG. 1 to coordinate the operations of other layers in a convolutional neural network (CNN), such as pooling layers, rectified linear units (ReLU) layers, and/or fully connected layers, with operations of a convolutional layer implemented using convolution hardware accelerator device/system 100. The coordination may include timing of the operations, locations of input tensors either received from an external source or generated by another layer in the CNN, locations of output tensors either to use as an input tensor for another layer in the CNN or to be provided as an output of the CNN. Scheduler 160, or one or more portions thereof, may be implemented in software (e.g., instructions, subroutines, code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both software and hardware.

Memory 170 may include suitable logic, circuitry, and/or code that enable storage of various types of information such as received data, generated data, code, and/or configuration information. For example, memory 170 may be configured to store one or more input tensors, one or more kernels, and/or one or more output tensors involved in the operations of convolution hardware accelerator device/system 100. Memory 170 may include, for example, random access memory (RAM), read-only memory (ROM), flash memory, magnetic storage, optical storage, etc.

Post processor 180 may be configured to perform one or more post-processing operations on the output tensor provided by convolution hardware accelerator device/system 100. For example, post processor 180 may be configured to apply bias functions, pooling functions, resizing functions, activation functions, etc. to the output tensor. Post processor 180, or one or more portions thereof, may be implemented in software (e.g., instructions, subroutines, code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both software and hardware.

As noted above, controller circuit 110 may be configured to parse a command and, using parameters from the command, configure and/or provide commands/instructions to feature processor circuit 120, weight processor circuit 130, MAC cells 140, and accumulator circuit 150 to perform a convolution operation. For example, controller circuit 110 may set or provide configuration parameters to components of MAC cells 140 to be used in the convolution operation. The components of MAC cells 140 and the configurations of the components used to support convolution operations are described in more detail below. In addition, controller circuit 110 may be configured to generate requests for input feature elements (first data elements) from an input tensor stored in memory 170 and for weight elements (second data elements) from a kernel stored in memory 170. The requests may be provided to a direct memory access controller configured to read out the input feature elements from memory 170 and provide the input feature elements to feature processor circuit 120, and to read out the weight elements from memory 170 and provide the weight elements to weight processor circuit 130.

According to aspects of the subject technology, feature processor circuit 120 includes suitable logic, circuitry, and/or code to receive the input feature elements (first data elements) from memory 170 and distribute the input feature elements among MAC cells 140. Similarly, weight processor circuit 130 includes suitable logic, circuitry, and/or code to receive the weight elements (second data elements) from memory 170 and distribute the weight elements among MAC cells 140.

According to aspects of the subject technology, MAC cells 140 includes an array of individual MAC cells each including suitable logic, circuitry, and/or code to multiply input feature elements received from feature processor circuit 120 by respective weight elements received from weight processor circuit 130 and sum the products of the multiplication operations. The components of each MAC cell are described in further detail below. The subject technology is not limited to any particular number of MAC cells and may be implemented using hundreds or even thousands of MAC cells.

A convolution operation executed by convolution hardware accelerator device/system 100 may include a sequence of cycles or iterations, where each cycle or iteration involves multiplying different combinations of input feature elements from an input tensor with different combinations of weight elements from a kernel and summing the products (e.g., dot product or scalar product). The sum output from each MAC cell during each cycle or iteration is provided to accumulator circuit 150. According to aspects of the subject technology, accumulator circuit 150 includes suitable logic, circuitry, and/or code to accumulate the sums provided by MAC cells 140 during the sequence of cycles or iterations to generate output feature elements of an output tensor representing the dot products or scalar products from the convolution of the input tensor with the kernel. Accumulator circuit 150 may include a buffer configured to store the sums provided by MAC cells 140 and interim values of output feature elements while they are being generated from the sums provided by MAC cells 140, and adders configured to add the sums received from MAC cells 140 to the values of the corresponding output feature elements stored in the buffer. Once the sequence of cycles or iterations is complete, accumulator circuit 150 may be configured to provide the generated output tensor comprising final values of the output feature elements stored in the buffer to post processor 180 for further processing.

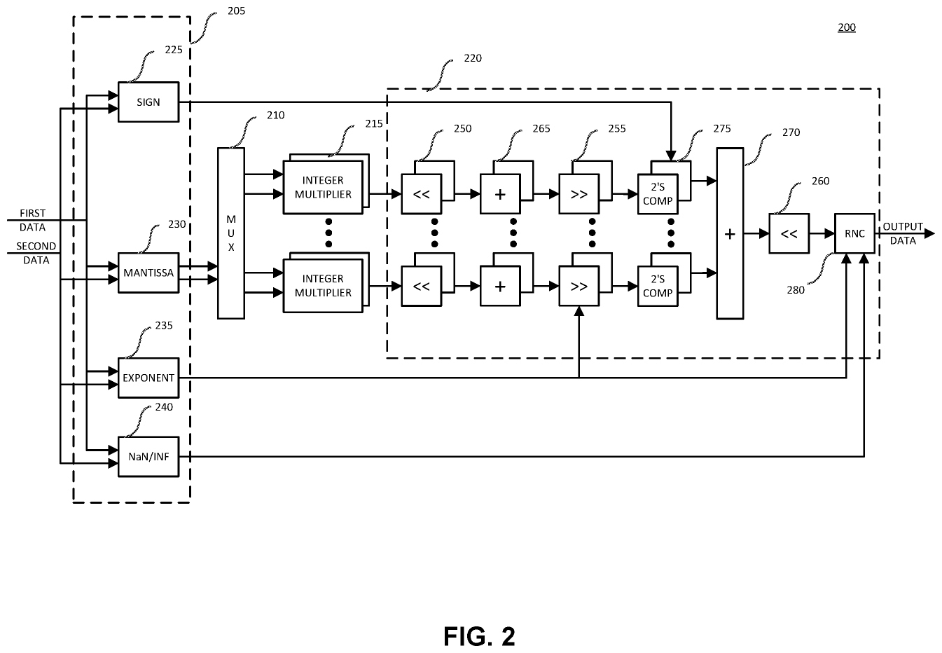

FIG. 2 is a block diagram depicting components of a MAC cell according to aspects of the subject technology. Not all of the depicted components may be required, however, and one or more implementations may include additional components not shown in the figure. Variations in the arrangement and type of the components may be made without departing from the spirit or scope of the claims as set forth herein. Depicted or described connections and couplings between components are not limited to direct connections or direct couplings and may be implemented with one or more intervening components unless expressly stated otherwise.

As depicted in FIG. 2, MAC cell 200 includes input circuits 205, multiplexer circuit 210, integer multiplier circuits 215, and output circuits 220. According to aspects of the subject technology, input circuits 205 are selectable and configurable by the controller circuit to receive input feature elements (first data elements) from the feature processor circuit and weight elements (second data elements) from the weight processor circuit and to process and/or provide the signs, exponents, and mantissas of the floating-point data elements to other components of MAC cell 200, as described below. Input circuits 205 may include, but are not limited to, sign circuit 225, mantissa circuit 230, exponent circuit 235, and not-a-number/infinite (NaN/INF) circuit 240.

According to aspects of the subject technology, sign circuit 225 includes suitable logic, circuitry, and/or code to extract sign bits from the input feature elements and the weight elements received from the feature processor circuit and the weight processor circuit to be multiplied as part of a convolution operation and determine output signs for the products of the input feature elements multiplied by the respective weight elements. The output signs are provided to output circuits 220 for further processing.

According to aspects of the subject technology, mantissa circuit 230 includes suitable logic, circuitry, and/or code to extract mantissas from the input feature elements and the weight elements received from the feature processor circuit and the weight processor circuit to be multiplied as part of the convolution operation. The bit size of the mantissas (the mantissa bit size) varies depending on the floating-point data type of the input feature elements and the weight elements. For example, 11-bit mantissas may be extracted from float16 data types and 24-bit mantissas may be extracted from float32 data types.

According to aspects of the subject technology, exponent circuit 235 includes suitable logic, circuitry, and/or code to extract exponents from the input feature elements and the weight elements received from the feature processor circuit and the weight processor circuit. Exponent circuit 235 may be configured further to sum the exponents extracted from the input feature element and the weight element of each feature-weight pair to be multiplied as part of the convolution operation and determine the largest of the exponent sums generated as a maximum exponent sum. Exponent sum 235 may be configured further to subtract the exponent sum for each feature-weight pair from the maximum exponent sum for each feature-weight pair to determine a difference between the maximum exponent sum and the respective exponent sum for the feature-weight pair. The maximum exponent sum and the respective differences between the maximum exponent sum and the respective exponent sums are provided to output circuits 220 for further processing.

According to aspects of the subject technology, NaN/INF circuit 240 includes suitable logic, circuitry, and/or code to determine if any of the input feature elements or weight elements received from the feature processor circuit or the weight processor circuit are not an actual number or represent an infinite value based on the format of the floating-point data type. For example, an element of the float32 data type may be determined to not be an actual number if the exponent is equal to 255 and the mantissa is not equal to zero. The element of the float32 data type may be determined to represent an infinite value if the exponent equals 255 and the mantissa equals zero. Input feature elements and weight elements determined to not be an actual number or determined to represent an infinite value are provided to output circuits 220 for further processing.

According to aspects of the subject technology, multiplexer circuit 210 includes suitable logic, circuitry, and/or code that may be configured by the controller circuit to distribute portions of the input feature elements and of the weight elements received from input circuits 205 to respective integer multiplier circuits of integer multiplier circuits 215. The distribution of the portions of the mantissas is described in further detail below.

According to aspects of the subject technology, integer multiplier circuits 215 include suitable logic, circuitry, and/or code that may be configured by the controller circuit to perform integer multiplication of respective pairs including a portion of the mantissa of an input feature element and a portion of the mantissa of a weight element received from multiplexer circuit 215 to generate respective partial products, which are provided to output circuits 220 for further processing. Integer multiplier circuits can be manufactured on smaller die spaces than that required by floating-point multiplier circuits. Accordingly, either more integer multiplier circuits can be arranged in the MAC cell than would be possible with floating-point multiplier circuits given the same die size, or the die size can be reduced to take advantage of the relatively smaller integer multiplier circuits. The bit size of the integer multiplier circuits (e.g., 8 bit, 9 bit, 11 bit) may be selected at design time to support different floating-point data types.

According to aspects of the subject technology, output circuits 220 are selectable and configurable by the controller circuit to receive the partial products generated by integer multiplier circuits 215 and to generate output feature/data elements based on the partial products and the signs and exponents of the floating-point data elements being multiplied for the convolution operation. The generated output data element is provided to the accumulator circuit. Output circuits 220 may include, but are not limited to, shift circuits 250, 255, and 260, integer adder circuits 265 and 270, conversion circuits 275, and composition (RNC) circuit 280.

According to aspects of the subject technology, shift circuits 250, 255, and 260 include suitable logic, circuitry, and/or code that may be selected and configured by the controller circuit to perform shift operations to shift bits of the sums or products provided to these circuits. Shift circuits 250, 255, and 260 are not limited to any particular type of shift circuit and may be implemented using barrel shifters, shift registers, etc. In addition, shift circuits 250, 255, and 260 are not limited to all using the same type of shift circuit. The direction of the shifts and the number of spaces by which the bits are shifted may be configured based on the data types of the input feature elements and the weight elements. Examples of the selection and configuration of shift circuits 250, 255, and 260 are provided below.

According to aspects of the subject technology, integer adder circuits 265 and 270 include suitable logic, circuitry, and/or code that may be selected and configured by the controller circuit to perform integer addition operations to generate sums of the values provided to these circuits. The subject technology is not limited to any particular number of integer adder circuits 265, nor to any particular numbers of inputs for integer adder circuits 265 and 270. Examples of the selection and configuration of integer adder circuits 265 and 270 are provided below.

According to aspects of the subject technology, conversion circuits 275 include suitable logic, circuitry, and/or code that may be selected and configured by the controller circuit to generate two's complements of signed integer values provided to conversion circuits 275. Converting signed integer values to two's complements allows integer addition to be performed by integer adder circuit 270 that maintains the proper sign of the sum. The values provide to conversion circuits 275 correspond to respective products of multiplying pairs of input feature elements and weight elements, and the signs of these respective products are provided to conversion circuits 275 by sign circuit 225. Examples of the selection and configuration of conversion circuits 275 are provided below.

According to aspects of the subject technology, RNC circuit 280 includes suitable logic, circuitry, and/or code that may be selected and configured by the controller circuit to generate an output data element that is provided to the accumulator circuit. The output data element may be a floating-point data type that includes a sign bit, exponent bits, and mantissa bits. The number of exponent bits and/or the number of mantissa bits may vary depending on the floating-point data type being used. Generating the output element may include converting the sum provided to RNC circuit 280 from two's complement to a signed-magnitude value to determine the sign bit of the output element.

RNC circuit 280 may be further configured to round the magnitude value to reduce the number of bits (e.g., 53 bits rounded to 30 bits) and normalize the rounded value. For example, the magnitude value may be represented by a number of integer bits (e.g., 7 bits) followed by a number of fraction bits (e.g., 46 bits). The magnitude value may be rounded by truncating a portion of the fraction bits to leave a desired number of fraction bits (e.g., 23 bits). The rounded value may be normalized by shifting the bits to the right until the leftmost “1” bit in the rounded value is in the first integer bit location. If the leftmost “1” bit is already in the first integer bit location, no shifting is required. RNC circuit 280 is configured to use the fraction bits after rounding and normalization as the mantissa of the output element. If NaN/INF circuit 240 determined that one of the input feature elements and/or one of the weight elements had an infinite value, RNC circuit 280 may be configured to receive the notification from NaN/INF circuit 240 and set the mantissa value for the output element to zero. If NaN/INF circuit 240 determined that one of the input feature elements and/or one of the weight elements was not a real number, RNC circuit 280 may be configured to receive the notification from NaN/INF circuit 240 and force the mantissa of the output element to a predetermined value (e.g., 0x400000).

RNC circuit 280 may be further configured to generate the exponent of the output element based on the maximum exponent sum provided by exponent circuit 235 to RNC circuit 280. For example, the exponent of the output element may be set to the maximum exponent sum minus 127. If the maximum exponent sum provided by exponent circuit 235 is zero, or if the magnitude value provided to RNC circuit 280 is zero before normalization, RNC circuit 280 may be configured to force the exponent of the output element to be zero. If NaN/INF circuit 240 determined that one of the input feature elements and/or one of the weight elements was either not a real number or had an infinite value, RNC circuit 280 may be configured to force the exponent of the output element to the value 255.

All the components of MAC cell 200 may be implemented in a single semiconductor device, such as a system on a chip (SoC). Alternatively, one or more of the components of MAC cell 200 may be implemented in a semiconductor device separate from the other components and mounted on a printed circuit board, for example, with the other components to form a system. In addition, one or more circuit elements may be shared between multiple circuit components depicted in FIG. 2. The subject technology is not limited to these two alternatives and may be implemented using other combinations of chips, devices, packaging, etc. to implement MAC cell 200.

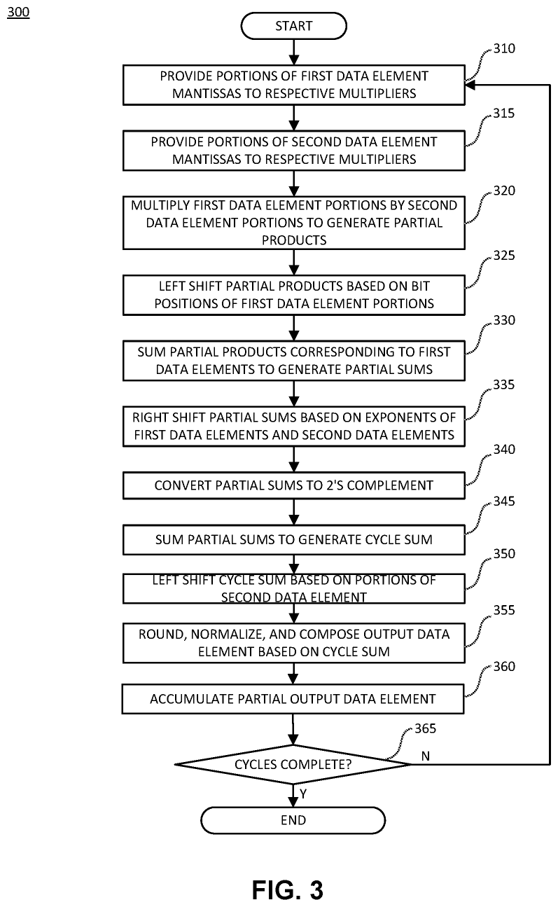

FIG. 3 contains a flowchart illustrating an example multiplication and accumulation operation of a MAC cell for a 32-bit floating-point data type (e.g., float32) according to aspects of the subject technology. For explanatory purposes, the blocks of process 300 are described herein as occurring in serial, or linearly. However, multiple blocks of process 300 may occur in parallel. In addition, the blocks of process 300 need not be performed in the order shown and/or one or more blocks of process 300 need not be performed and/or can be replaced by other operations.

The operation of MAC cell 200 depicted in FIG. 2 will be described using the multiplication and accumulation process 300 illustrated in FIG. 3. The general operations of the components of MAC cell 200 are described above and will not be repeated here.

According to aspects of the subject technology, process 300 may be started when the feature processor circuit provides a set of input feature elements to MAC cell 200 and the weight processor circuit provides a set of weight element to MAC cell 200. For example, a set of eight input feature element and a set of eight weight elements may be provided to MAC cell 200 for a multiplication and accumulation operation. Mantissa circuit 230 may extract the mantissas from each of the input feature elements and each of the weight elements, which may be read out from mantissa circuit 230 or received from mantissa circuit 230 by multiplexer circuit 210 to be distributed to respective integer multiplier circuits of integer multiplier circuits 215.

The mantissas extracted from elements of a float32 data type have 24 bits, which is larger than can be accommodated by an eight-bit integer multiplier circuit. Accordingly, multiplexer circuit 310 cannot provide the complete mantissa extracted from an input feature element and the complete mantissa extracted from a weight element to an eight-bit integer multiplier circuit for multiplication. According to aspects of the subject technology, multiplexer circuit 210 may be configured to divide the mantissas into portions and provide individual portions from the mantissas extracted from the input feature elements to respective integer multiplier circuits (block 310) and individual portions from the mantissas extracted from the weight elements to respective multiplier circuits (block 315) for multiplication.

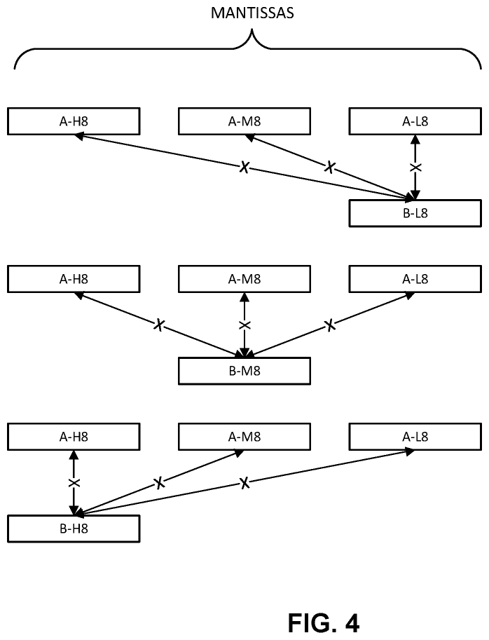

FIG. 4 is a block diagram depicting multiplication operations performed by the integer multiplier circuits on the portions of the mantissas according to aspects of the subject technology. According to aspects of the subject technology, each 24-bit mantissa extracted from an input feature element (first data element) may be divided into three eight-bit portions represented in FIG. 4 as A-L8 for the least-significant portion including the least-significant eight bits of the mantissa, A-M8 for the middle portion including the eight bits from the eight middle-bit positions of the mantissa, and A-H8 for the most-significant portion including the most-significant eight bits of the mantissa. Similarly, each 24-bit mantissa extracted from a weight element (second data element) may be divided into three eight-bit portions represented in FIG. 4 as B-L8 for the least-significant portion including the least-significant eight bits of the mantissa, B-M8 for the middle portion including the eight bits from the eight middle-bit positions of the mantissa, and B-H8 for the most-significant portion including the most-significant eight bits of the mantissa.

In the example presented in FIG. 4, multiplying two 24-bit mantissas using 8-bit integer multiplier circuits involves nine multiplication operations generating nine partial products that are summed to generate the product of the two 24-bit mantissas. MAC cell 200 may be configured to receive a set of eight input feature elements (first data elements) and a set of eight weight elements (second data elements) for multiplication and accumulation. Multiplying the mantissas of the eight input feature elements with respective mantissas of the eight weight elements would involve 72 multiplication operations. According to aspects of the subject technology, MAC cell 200 may be implemented with 32 integer multiplier circuits. With 32 integer multiplier circuits, the 72 multiplication operations would need three cycles (72 operations/32 multipliers=2.25) to complete and would result in a 75% utilization of the hardware of MAC cell 200 over the three cycles.

According to aspects of the subject technology, the number of multiplication operations involved in multiplying two 24-bit mantissas is reduced by excluding the partial product of the least-significant portion of the mantissa of the input feature element (A-L8) and the least-significant portion of the mantissa of the weight element (B-L8) from the process. Accordingly, multiplexer circuit 210 may be configured to bypass providing the least-significant portion of the mantissa of the input feature element to one of integer multiplier circuits 215 for multiplication with the least-significant portion of the mantissa of the weight element. Reducing the number of multiplication operations used for each pair of mantissas from nine down to eight also reduces the number of cycles used to complete the multiplication process from three cycles down to two cycles (64 operations/32 multipliers=2), which is 1.5 times faster than if all nine multiplication operations were executed and may result in 100% utilization of the hardware of MAC cell 200 over the two cycles with no additional hardware required and minimal impact on accuracy since the least-significant partial product is excluded from the process. In addition, nine is an awkward number for scalable computing applications such as machine learning. The design and implementation of scalable computing applications may favor values that are a power of two. Reducing the number of multiplication operations to eight, which is a power of two, may simplify aspects of implementing the subject technology.

According to aspects of the subject technology, multiplexer circuit 210 may be configured to provide portions of the mantissas of the input feature elements to respective integer multiplier circuits of integer multiplier circuits 215 (block 310) and portions of the mantissas of the weight elements to respective integer multiplier circuits of integer multiplier circuits 215 (block 315) for multiplication.

The integer multiplier circuits may be configured to multiply the respective portions from the input feature element mantissas by the respective portions from the weight element mantissas in parallel to generate respective partial products (block 320). The bits of the partial products may need to be shifted to the left depending on the bit positions of the portion from the input feature element mantissa multiplied to generate the partial products. For example, partial products generated by multiplying the A-M8 portion of the mantissa (the middle eight bits of the mantissa) need to be shifted eight bits to the left and partial products generated by multiplying the A-H8 portion of the mantissa (the upper eight bits of the mantissa) need to be shifted sixteen bits to the left. According to aspects of the subject technology, individual shift circuits of shift circuits 250 may be coupled to respective integer multiplier circuits of integer multiplier circuits 215. The controller circuit may select and configure the shift circuits coupled to integer multiplier circuits that receive and multiply either the A-M8 portion or the A-H8 portion to shift the partial products either 8 bits to the left or 16 bits to the left, respectively (block 325).

According to aspects of the subject technology, integer adder circuits 265 may be selected and configured by the controller circuit to sum partial products that are generated using portions from the same input feature element mantissa (block 330). For example, referring to FIG. 4, the partial products generated by multiplying A-M8 by B-L8, and A-H8 by B-L8, and A-L8 by B-M8 in the first cycle are added together by integer adder circuits 265 to generate a partial sum. Shift circuits 255 may be selected and configured by the controller circuit to shift the partial sums to the right based on the differences between the maximum exponent sum and the respective exponent sums generated and provided by exponent circuit 235 (block 335). For example, each partial sum is generated using the portions of the mantissa from a respective input feature element and a portion of the mantissa from a respective weight element. The sum of the exponents from the respective input feature element and the respective weight element is subtracted from the maximum exponent sum by exponent circuit 235 and shift circuits 255 are configured to shift the partial sum a number of bits to the right equal to the difference.

Conversion circuit 275 may be selected and configured by the controller circuit to generate two's complements of the partial sums based on the output signs provided by sign circuit 225 (block 340). For example, if the output sign determined by sign circuit 225 for an input feature element and weight element pair is negative, a two's complement of the partial sum generated using the mantissas for that pair is generated. If the output sign determined by sign circuit 225 is positive, the partial sum is left unchanged. Integer adder circuit 270 may be selected and configured by the controller circuit to sum the partial sums to generate a sum for the cycle (block 345). An advantage of converting the negative partial sums to two's complements is that integer adder circuit 270 can use addition operations identical to those used for unsigned integer values rather than the more complicated addition operations used for adding signed integer values.

According to aspects of the subject technology, shift circuit 260 may be selected and configured by the controller circuit to shift the sum for the cycle to the left based on portions of the weight element being multiplied during the cycle (block 350). The cycle count may be referenced to determine the bit position of the portions of the mantissas from the weight elements multiplied by the respective portions of the mantissas from the input feature elements. Referring again to FIG. 4, the B-L8 portion of the mantissa (least significant eight bits) is used in the multiplication operations executed by integer multiplier circuits 215 and no shift is required. However, when the B-M8 portion (middle eight bits of the mantissa) is used in the multiplication operations, a shift of the sum to the left by eight bits to account for the bit position of the B-M8 portion in the mantissa. Similarly, when the B-H8 portion (most significant eight bits of the mantissa) is used in the multiplication operations which requires a shift of the sum to the left by sixteen bits to account for the bit position of the B-H8 portion in the mantissa.

According to aspects of the subject technology, composition (RNC) circuit 280 may be selected and configured by the controller circuit to generate an output element based on the sum received from shift circuit 260 (block 355). As discussed above, RNC circuit 285 may be configured to convert the sum from two's complement to a signed-magnitude format to determine the sign bit for the output element. RNC circuit 285 may further round and normalize the magnitude value to determine the mantissa bits for the output element. Finally, RNC circuit 285 determines the exponent bits for the output element based on the maximum exponent sum provided by exponent circuit 235. The generated output element is provided to the accumulation circuit to be accumulated with output elements from other MAC cells and from different cycles to generate the output tensor (block 360). If all of the combinations of portions of the mantissas from the input feature elements and from the weight elements have been applied in multiplication operations (i.e., cycles are complete) (block 365), the multiplication and accumulation process ends. If one or more portions of the mantissas from the input feature elements and/or the weight elements have yet to be applied in multiplication operations (i.e., cycles remain) (block 365), multiplexer circuit 210 provides the next portions of the mantissas from the input feature elements to the respective integer multipliers (block 310) and the next portions of the mantissas from the weight elements to the respective integer multipliers (block 315) and the process repeats the foregoing operations for the next cycle.

The foregoing example described a multiplication and accumulation process for input feature elements and weight elements of a float32 data type. The configuration of MAC cell 200 and process 300 also may be applied to other data types. For example, the input feature elements and the weight elements provided to MAC cell 200 for the multiplication and accumulation process may be a float16 data type. For the float16 data type, sixteen input feature elements and sixteen weight elements may be provided to MAC cell 200. The bit size of the mantissa extracted from the input feature elements and the weight elements may be eleven bits.

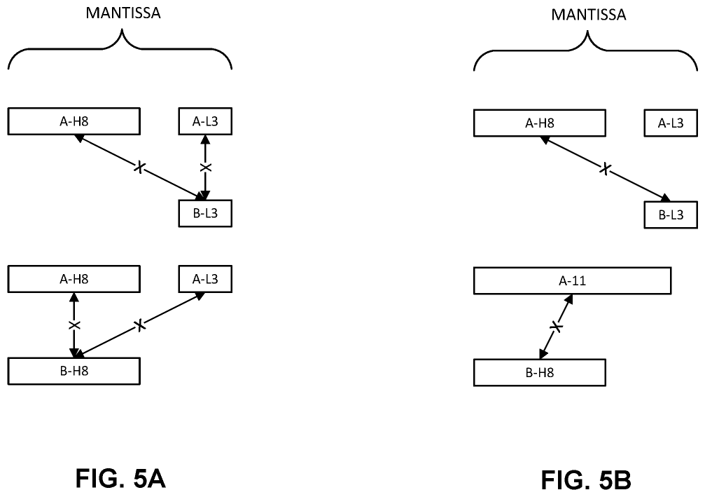

Similar to process for the float32 data type, portions of the mantissas extracted from the input feature elements and from the weight elements are provided to respective ones of the integer multiplier circuits as described above in connection with process 300. FIGS. 5A and 5B are block diagram depicting multiplication operations performed by the integer multiplier circuits on the portions of the mantissas according to aspects of the subject technology. As depicted in FIG. 5A, the 11-bit mantissas extracted from each of the input feature elements are divided into least-significant portion A-L3 (containing the least significant three bits of the mantissa) and most-significant portion A-H8 (containing the most significant eight bits of the mantissa. Similarly, the 11-bit mantissa extracted from each of the weight elements is divided into a least-significant portion B-L3 (containing the least-significant three bits of the mantissa) and most-significant portion B-H8 (containing the most-significant eight bits of the mantissa). The subject technology is not limited to this division of the mantissas and may be implemented with different bit counts for the different portions of each mantissa.

In the example presented in FIG. 5A, multiplying two 11-bit mantissas using 8-bit integer multiplier circuits involves four multiplication operations generating four partial products that are summed to generate the product of the two 11-bit mantissas. MAC cell 200 may be configured to receive a set of sixteen input feature elements (first data elements) and a set of sixteen weight elements (second data elements) for multiplication and accumulation. Multiplying the mantissas of the sixteen input feature elements with respective mantissas of the sixteen weight elements would involve 64 multiplication operations. According to aspects of the subject technology, MAC cell 200 may be implemented with 32 integer multiplier circuits. With 32 integer multiplier circuits, the 64 multiplication operations would need two cycles (64 operations/32 multipliers=2) to complete.

According to aspects of the subject technology, the number of multiplication operations involved in multiplying two 11-bit mantissas is reduced in two ways. First, the number of multiplication operations is reduced by excluding the partial product of the least-significant portion of the mantissa of the input feature element (A-L3) and the least-significant portion of the mantissa of the weight element (B-L3) from the process. Accordingly, multiplexer circuit 210 may be configured to bypass providing the least-significant portion of the mantissa of the input feature element to one of integer multiplier circuits 215 for multiplication with the least-significant portion of the mantissa of the weight element. This reduction alone reduces the number of multiplication operations for the two 11-bit mantissas to three. As noted above, scalable computing applications such as machine learning may prefer powers of two.

Second, the number of multiplication operations involved in multiplying two 11-bit mantissas is reduced by providing the entire 11-bit mantissa of the input feature element (A-11) to be multiplied by the most significant portion of the weight element (B-H8). This modification requires the use of 11-bit integer multiplier circuits. However, only one of the two multiplication operations requires an 11-bit integer multiplier circuit, so only half of the integer multiplier circuits needs to be 11-bits with the remaining half of the integer multiplier circuits being 8-bit. This results in an increase in hardware area (e.g., 11%) to get the benefit of reducing the number of multiplication operations.

Reducing the number of multiplication operations used for each pair of mantissas from four down to two (power of two) also reduces the number of cycles used to complete the multiplication process from two cycles down to one cycle (32 operations/32 multipliers=1), which is 2 times faster than if all four multiplication operations were executed and may result in 100% utilization of the hardware of MAC cell 200 and have minimal impact on accuracy since the least-significant partial product is excluded from the process. According to aspects of the subject technology, blocks 310 through 355 of process 300 are repeated for the sixteen input feature elements and the sixteen weight elements of the float16 data type.

The configurations of MAC cell 200 in which multiplication operations are reduced by excluding the least-significant partial product and/or by increasing the size of a subset of the integer multiplier circuits may be selectable. In this manner, a command may be received by the controller circuit to configure the components of the MAC cells to disable the exclusion of the least-significant partial product from the process. In this manner, the full precision of the multiplication of input feature elements by weight elements may be restored.

According to aspects of the subject technology, a device is provided that includes a plurality of integer multiplier circuits; a multiplexer circuit configured to provide portions of mantissas of a set of first data elements having a floating-point data type and portions of mantissas of a set of second data elements having the floating-point data type to respective integer multiplier circuits of the plurality of integer multiplier circuits, wherein each integer multiplier circuit is configured to multiply a respective portion of the mantissa of a first data element by a respective portion of the mantissa of a second data element to generate a partial product; and output circuits configured to generate an output data element based on the partial products generated by the plurality of integer multiplier circuits and exponents of the set of first data elements and of the set of second data elements. The multiplexer circuit is further configured to bypass providing least-significant portions of the mantissas of the set of first data elements to integer multiplier circuits of the plurality of integer multiplier circuits for multiplication with least-significant portions of the mantissas of the set of second data elements.

A mantissa bit size of the floating-point data type may be twenty-four bits, and the portions of the mantissas provided to the plurality of integer multiplier circuits may comprise the least-significant portions each including eight bits from eight least-significant bit positions of the respective mantissas, middle portions each including eight bits from eight middle-bit positions of the respective mantissas, and most-significant portions each including eight bits from eight most-significant bit positions of the respective mantissas.

The plurality of integer multiplier circuits may include a first set of integer multiplier circuits having a first bit size; and a second set of integer multiplier circuits having a second bit size different from the first bit size. A mantissa bit size of the floating-point data type may be eleven bits, and the portions of the mantissas provided to the plurality of integer multiplier circuits may comprise the least-significant portions each including three bits from three least-significant bit positions of the respective mantissas, most-significant portions each including eight bits from eight most-significant bit positions of the respective mantissas, and complete portions comprising all eleven bits of the respective mantissas. The bit size of the first set of integer multiplier circuits may be eleven bits and the bit size of the second set of integer multiplier circuits may be eight bits.

The output circuits may include a first shift circuit configured to shift bits of the partial products based on the exponents of the set of first data elements and of the set of second data elements; a first integer adder circuit configured to add the shifted partial products to generate a sum; and a composition circuit configured to generate the output data element based on the sum generated by the first integer adder circuit.

The set of first data elements may be paired with the set of second data elements, respectively, to form a plurality of data-element pairs. The device may further comprise an exponent circuit configured to: add the exponents of the first data element and the second data element for each data-element pair to generate a respective exponent sum; determine a maximum exponent sum from the respective exponent sums; and for each data-element pair, determine a difference between the maximum exponent sum and the respective exponent sum, wherein the first shift circuit is configured to shift the bits of the partial products based on the respective differences between the maximum exponent sum and the respective exponent sums, and wherein the output data element is generated based on the maximum exponent sum.

The device may further include a sign circuit configured to determine an output sign for each data-element pair based on sign bits of the respective first data elements and second data elements, wherein the output circuits further comprise a conversion circuit configured to generate two's complements of the shifted partial products based on the respective output signs prior to being added by the first integer adder circuit.

The composition circuit may be further configured to convert the sum generated by the first integer adder circuit from two's complement to signed-magnitude format; and round the converted sum to a predetermined bit length, wherein a sign bit of the output data element is based on the converted sum, an exponent of the output data element is based on the determined maximum exponent sum, and a mantissa of the output data element is based on the rounded sum.

The composition circuit may be further configured to normalize the rounded sum, and adjust the maximum exponent sum based on the normalization, wherein the exponent of the output data element is based on the adjusted maximum exponent sum and the mantissa of the output data element is based on the normalized sum. The multiplexer circuit may be further configured to provide different combinations of the portions of the mantissas of the set of first data elements and of the set of second data elements to the plurality of integer multiplier circuits during different respective cycles of the device.

The device may further include a second shift circuit configured to shift bits of the partial products generated by the different respective integer multiplier circuits based on a bit position of the portion of the mantissa of the first data element multiplied to generate the respective partial products, and a second integer adder circuit configured to add the shifted partial products corresponding to each of the first data elements to generate respective partial sums, wherein the first shift circuit is configured to shift the bits of the partial sums based on the determined difference between the maximum exponent sum and the respective exponent sum of the corresponding data-element pair, wherein the conversion circuit is configured to generate two's complements of the shifted partial sums, and wherein the first integer adder circuit is configured to add the shifted partial sums to generate the sum. The output circuits may further comprise a third shift circuit configured to shift bits of the sum generated by the first integer adder circuit based on a cycle count of the device, wherein the composition circuit generates the output data element based on the shifted sum.

According to aspects of the subject technology, a device is provided that includes a plurality of integer multiplier circuits, a multiplexer circuit configured to provide to each integer multiplier circuit of the plurality of multiplier circuits a respective portion of a mantissa of a set of first data elements having a floating-point data type and a respective portion of a mantissa of a set of second data elements having the floating-point data type to be multiplied to generate a respective partial product, wherein each integer multiplier circuit is provided a different pair of portions of the mantissas of the set of first data elements and of the set of second data elements, and wherein the pairs of portions of the mantissas do not include a pair comprising a least-significant portion of a mantissa of the set of first data elements and a least-significant portion of a mantissa of the set of second data elements, and output circuits configured to generate an output data element based on the partial products generated by the plurality of integer multiplier circuits and exponents of the set of first data elements and of the set of second data elements.

A mantissa bit size of the floating-point data type may be twenty-four bits, and the portions of the mantissas provided to the plurality of integer multiplier circuits may comprise the least-significant portions each including eight bits from eight least-significant bit positions of the respective mantissas, middle portions each including eight bits from eight middle-bit positions of the respective mantissas, and most-significant portions each including eight bits from eight most-significant bit positions of the respective mantissas.

The plurality of integer multiplier circuits comprises a first set of integer multiplier circuits having a first bit size, and a second set of integer multiplier circuits having a second bit size different from the first bit size. A mantissa bit size of the floating-point data type may be eleven bits, wherein the portions of the mantissas provided to the plurality of integer multiplier circuits may comprise the least-significant portions each including three bits from three least-significant bit positions of the respective mantissas, most-significant portions each including eight bits from eight most-significant bit positions of the respective mantissas, and complete portions comprising all eleven bits of the respective mantissas, and the bit size of the first set of integer multiplier circuits may be eleven bits and the bit size of the second set of integer multiplier circuits may be eight bits.

According to aspects of the subject technology, a system is provided that includes a controller circuit, an accumulator circuit, and a plurality of multiplication and accumulation (MAC) cells. Each of the plurality of MAC cells includes a plurality of integer multiplier circuits, input circuits configured to receive a set of first data elements having a floating-point data type and a set of second data elements having the floating-point data type, a multiplexer circuit configured to provide portions of mantissas of the set of first data elements and portions of mantissas of the set of second data elements to respective integer multiplier circuits of the plurality of integer multiplier circuits, wherein each integer multiplier circuit is configured to multiply a respective portion of the mantissa of a first data element by a respective portion of the mantissa of a second data element to generate a partial product, and output circuits configured to generate an output data element based on the partial products generated by the plurality of integer multiplier circuits and exponents of the set of first data elements and of the set of second data elements and provide the output data element to the accumulator circuit. The multiplexer circuit is further configured to bypass providing least-significant portions of the mantissas of the set of first data elements to integer multiplier circuits of the plurality of integer multiplier circuits for multiplication with least-significant portions of the mantissas of the set of second data elements, wherein the accumulator circuit is configured to accumulate the output data elements generated by the plurality of MAC cells to generate an output tensor.

A mantissa bit size of the floating-point data type may be twenty-four bits, and wherein the portions of the mantissas provided to the plurality of integer multiplier circuits may comprise the least-significant portions each including eight bits from eight least-significant bit positions of the respective mantissas, middle portions each including eight bits from eight middle-bit positions of the respective mantissas, and most-significant portions each including eight bits from eight most-significant bit positions of the respective mantissas.

A mantissa bit size of the floating-point data type may be eleven bits, wherein the portions of the mantissas provided to the plurality of integer multiplier circuits may comprise the least-significant portions each including three bits from three least-significant bit positions of the respective mantissas, most-significant portions each including eight bits from eight most-significant bit positions of the respective mantissas, and complete portions comprising all eleven bits of the respective mantissas, and wherein a bit size of a first set of integer multiplier circuits from the plurality of integer multiplier circuits may beeleven bits and a bit size of a second set of integer multiplier circuits from the plurality of integer multiplier circuits may be eight bits.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

What is claimed is:

1. A device, comprising:
a plurality of integer multiplier circuits;
a multiplexer circuit configured to provide portions of mantissas of a set of first data elements having a floating-point data type and portions of mantissas of a set of second data elements having the floating-point data type to respective integer multiplier circuits of the plurality of integer multiplier circuits, wherein each integer multiplier circuit is configured to multiply a respective portion of the mantissa of a first data element by a respective portion of the mantissa of a second data element to generate a partial product; and
output circuits configured to generate an output data element based on the partial products generated by the plurality of integer multiplier circuits and exponents of the set of first data elements and of the set of second data elements,
wherein the multiplexer circuit is further configured to bypass providing least-significant portions of the mantissas of the set of first data elements to integer multiplier circuits of the plurality of integer multiplier circuits for multiplication with least-significant portions of the mantissas of the set of second data elements.

2. The device of claim 1, wherein a mantissa bit size of the floating-point data type is twenty-four bits, and
wherein the portions of the mantissas provided to the plurality of integer multiplier circuits comprise the least-significant portions each including eight bits from eight least-significant bit positions of the respective mantissas, middle portions each including eight bits from eight middle-bit positions of the respective mantissas, and most-significant portions each including eight bits from eight most-significant bit positions of the respective mantissas.

3. The device of claim 1, wherein the plurality of integer multiplier circuits comprises:
a first set of integer multiplier circuits having a first bit size; and
a second set of integer multiplier circuits having a second bit size different from the first bit size.

4. The device of claim 3, wherein a mantissa bit size of the floating-point data type is eleven bits, and
wherein the portions of the mantissas provided to the plurality of integer multiplier circuits comprises the least-significant portions each including three bits from three least-significant bit positions of the respective mantissas, most-significant portions each including eight bits from eight most-significant bit positions of the respective mantissas, and complete portions comprising all eleven bits of the respective mantissas.

5. The device of claim 4, wherein the bit size of the first set of integer multiplier circuits is eleven bits and the bit size of the second set of integer multiplier circuits is eight bits.

6. The device of claim 1, wherein the output circuits comprise:
a first shift circuit configured to shift bits of the partial products based on the exponents of the set of first data elements and of the set of second data elements;
a first integer adder circuit configured to add the shifted partial products to generate a sum; and
a composition circuit configured to generate the output data element based on the sum generated by the first integer adder circuit.

7. The device of claim 6, wherein the set of first data elements are paired with the set of second data elements, respectively, to form a plurality of data-element pairs,
wherein the device further comprises an exponent circuit configured to:
add the exponents of the first data element and the second data element for each data-element pair to generate a respective exponent sum;
determine a maximum exponent sum from the respective exponent sums; and
for each data-element pair, determine a difference between the maximum exponent sum and the respective exponent sum,
wherein the first shift circuit is configured to shift the bits of the partial products based on the respective differences between the maximum exponent sum and the respective exponent sums, and
wherein the output data element is generated based on the maximum exponent sum.

8. The device of claim 7, further comprising:
a sign circuit configured to determine an output sign for each data-element pair based on sign bits of the respective first data elements and second data elements,
wherein the output circuits further comprise a conversion circuit configured to generate two's complements of the shifted partial products based on the respective output signs prior to being added by the first integer adder circuit.

9. The device of claim 8, wherein the composition circuit is further configured to:
convert the sum generated by the first integer adder circuit from two's complement to signed-magnitude format; and
round the converted sum to a predetermined bit length,
wherein a sign bit of the output data element is based on the converted sum, an exponent of the output data element is based on the determined maximum exponent sum, and a mantissa of the output data element is based on the rounded sum.

10. The device of claim 9, wherein the composition circuit is further configured to:
normalize the rounded sum; and
adjust the maximum exponent sum based on the normalization,
wherein the exponent of the output data element is based on the adjusted maximum exponent sum and the mantissa of the output data element is based on the normalized sum.

11. The device of claim 10, wherein the multiplexer circuit is further configured to:
provide different combinations of the portions of the mantissas of the set of first data elements and of the set of second data elements to the plurality of integer multiplier circuits during different respective cycles of the device.

12. The device of claim 11, further comprising:
a second shift circuit configured to shift bits of the partial products generated by the different respective integer multiplier circuits based on a bit position of the portion of the mantissa of the first data element multiplied to generate the respective partial products; and
a second integer adder circuit configured to add the shifted partial products corresponding to each of the first data elements to generate respective partial sums,
wherein the first shift circuit is configured to shift the bits of the partial sums based on the determined difference between the maximum exponent sum and the respective exponent sum of the corresponding data-element pair,
wherein the conversion circuit is configured to generate two's complements of the shifted partial sums, and
wherein the first integer adder circuit is configured to add the shifted partial sums to generate the sum.

13. The device of claim 12, wherein the output circuits further comprise:
a third shift circuit configured to shift bits of the sum generated by the first integer adder circuit based on a cycle count of the device,
wherein the composition circuit generates the output data element based on the shifted sum.

14. A device, comprising:
a plurality of integer multiplier circuits;
a multiplexer circuit configured to provide to each integer multiplier circuit of the plurality of multiplier circuits a respective portion of a mantissa of a set of first data elements having a floating-point data type and a respective portion of a mantissa of a set of second data elements having the floating-point data type to be multiplied to generate a respective partial product, wherein each integer multiplier circuit is provided a different pair of portions of the mantissas of the set of first data elements and of the set of second data elements, and wherein the pairs of portions of the mantissas do not include a pair comprising a least-significant portion of a mantissa of the set of first data elements and a least-significant portion of a mantissa of the set of second data elements; and
output circuits configured to generate an output data element based on the partial products generated by the plurality of integer multiplier circuits and exponents of the set of first data elements and of the set of second data elements.

15. The device of claim 14, wherein a mantissa bit size of the floating-point data type is twenty-four bits, and
wherein the portions of the mantissas provided to the plurality of integer multiplier circuits comprise the least-significant portions each including eight bits from eight least-significant bit positions of the respective mantissas, middle portions each including eight bits from eight middle-bit positions of the respective mantissas, and most-significant portions each including eight bits from eight most-significant bit positions of the respective mantissas.

16. The device of claim 14, wherein the plurality of integer multiplier circuits comprises:
a first set of integer multiplier circuits having a first bit size; and
a second set of integer multiplier circuits having a second bit size different from the first bit size.

17. The device of claim 16, wherein a mantissa bit size of the floating-point data type is eleven bits,
wherein the portions of the mantissas provided to the plurality of integer multiplier circuits comprises the least-significant portions each including three bits from three least-significant bit positions of the respective mantissas, most-significant portions each including eight bits from eight most-significant bit positions of the respective mantissas, and complete portions comprising all eleven bits of the respective mantissas, and
wherein the bit size of the first set of integer multiplier circuits is eleven bits and the bit size of the second set of integer multiplier circuits is eight bits.

18. A system, comprising:
a controller circuit;
an accumulator circuit; and
a plurality of multiplication and accumulation (MAC) cells, wherein each of the plurality of MAC cells comprises:
a plurality of integer multiplier circuits;
input circuits configured to receive a set of first data elements having a floating-point data type and a set of second data elements having the floating-point data type;
a multiplexer circuit configured to provide portions of mantissas of the set of first data elements and portions of mantissas of the set of second data elements to respective integer multiplier circuits of the plurality of integer multiplier circuits, wherein each integer multiplier circuit is configured to multiply a respective portion of the mantissa of a first data element by a respective portion of the mantissa of a second data element to generate a partial product; and
output circuits configured to generate an output data element based on the partial products generated by the plurality of integer multiplier circuits and exponents of the set of first data elements and of the set of second data elements and provide the output data element to the accumulator circuit,
wherein the multiplexer circuit is further configured to bypass providing least-significant portions of the mantissas of the set of first data elements to integer multiplier circuits of the plurality of integer multiplier circuits for multiplication with least-significant portions of the mantissas of the set of second data elements,
wherein the accumulator circuit is configured to accumulate the output data elements generated by the plurality of MAC cells to generate an output tensor.

19. The system of claim 18, wherein a mantissa bit size of the floating-point data type is twenty-four bits, and
wherein the portions of the mantissas provided to the plurality of integer multiplier circuits comprise the least-significant portions each including eight bits from eight least-significant bit positions of the respective mantissas, middle portions each including eight bits from eight middle-bit positions of the respective mantissas, and most-significant portions each including eight bits from eight most-significant bit positions of the respective mantissas.

20. The system of claim 18, wherein a mantissa bit size of the floating-point data type is eleven bits,
wherein the portions of the mantissas provided to the plurality of integer multiplier circuits comprises the least-significant portions each including three bits from three least-significant bit positions of the respective mantissas, most-significant portions each including eight bits from eight most-significant bit positions of the respective mantissas, and complete portions comprising all eleven bits of the respective mantissas, and
wherein a bit size of a first set of integer multiplier circuits from the plurality of integer multiplier circuits is eleven bits and a bit size of a second set of integer multiplier circuits from the plurality of integer multiplier circuits is eight bits.
